(19) United States
(12) Patent Application Publication
(10) Pub. No.: US 2008/0011731 A1
(43) Pub. Date: Jan. 17, 2008

(54) Carbon to weld metal

(75) Inventors: Ashish Kapoor, Highland Heights, OH (US); Teresa A. Melfi, Kirtland, OH (US)

Correspondence Address: FAY SHARPE / LINCOLN, 1100 SUPERIOR AVENUE, SEVENTH FLOOR, CLEVELAND, OH, 44114, US

(73) Assignee: Lincoln Global, Inc.

(21) Appl. No.: 11/484,052

(22) Filed: Jul. 11, 2006

(51) Int. Cl. B23K 35/24

(52) U.S. Cl. 219/146.31

(57) ABSTRACT

Various flux compositions for increasing carbon contents in welds are disclosed. The flux compositions can be provided in a variety of different forms such as in an agglomerated form, fused form, sintered form, or provided as a coating. The fluxes are particularly adapted for use in submerged arc welding processes.

The present invention relates to techniques for increasing carbon content in welds without the problems otherwise associated therewith. The invention also relates to electrode and/or flux compositions for achieving such increased carbon contents. The increased carbon provides the advantage of retaining weld metal strength levels after Post Weld Heat Treatment procedures. The invention is particularly adapted for use in submerged arc welding (SAW) processes.

### BACKGROUND OF INVENTION

In welded assemblies, welding itself is a frequent cause of significant residual stress. After welding, the cooler parent metal restrains contraction of the weld metal, thereby leading to large residual stresses in the welded assembly. In addition, phase and volumetric changes at the microscopic level can also contribute to residual stresses during welding.

Specifically, large thermal stress gradients can exist in the vicinity of welded joints due to the localized heating and subsequent cooling of the weld zone. Resulting contractions can cause weld cracking or distortion. Furthermore, welded strained structures can become susceptible to hydrogen embrittlement. Residual stresses can become particularly problematic in view of stress concentration at joints and the potential for detrimental microstructures in the heat affected zone (HAZ) of the weld.

Residual stresses can be relieved by stress relieving techniques. The most common form of stress relief is by heat treatment. Thermal stress relieving involves heating the stressed component to a temperature at which the material yield stress has fallen, thereby allowing creep to occur. Large residual stresses are no longer supported and if the temperatures are high enough, the stress distribution will become more uniform across the component. Such heat treatment may also lead to tempering and alterations of the microstructure depending upon the material and heating parameters.

Specifically, for welded assemblies, one or more postweld heat treatments may be performed. These treatments are stress relieving processes whereby residual stresses are reduced by heating to temperatures generally from about 550° C. to about 650° C. and maintaining such temperature for a predetermined time period, such as from about 30 minutes to about several hours, and then cooling according to particular cooling profiles.

In addition to reducing residual stresses, postweld heating operations can also lead to additional benefits such as promoting diffusion of hydrogen from the weld metal, softening the hardened metal in the region of the heat affected zone (HAZ) thus improving toughness, improving ductibility, improving resistance to cracking and improving overall dimensional stability.

Although often beneficial in many aspects, heating of weldments can also have detrimental consequences. Generally, heating is time consuming and costly. In addition, prolonged heating can reduce the hardness of the weld and decrease the tensile strength of the weld by reducing the internal energy of the weld metal and also promoting grain growth in the microstructure. Also, several customer specifications especially in the offshore industry call for maintaining a maximum hardness level in the weld metal after stress relief. This drives customers to higher stress relief temperatures, which in turn leads to more loss of strength.

Prior artisans have addressed this problem of loss of strength by adding carbon or carbon-containing agents in the electrode in hopes of increasing the carbon content of the resulting weld. U.S. Pat. No. 3,947,655 describes cored electrodes for welding steel. The filler material of such electrodes contains carbon up to 0.4% by weight of the electrode. Electrodes of higher carbon contents are disclosed in U.S. Pat. No. 5,015,823. A cored electrode containing 0.4 to 0.72% carbon, based upon the total weight of the electrode, is disclosed. More recently, U.S. Pat. 5,304,346 described welding materials with carbon contents of 0.05 to 0.5%.

However, several problems arise by simply adding carbon or carbon-containing agents in the electrode or flux. Excessive carbon, if occurring in the resulting weld, can cause the weld to be excessively hard or brittle. Moreover, it is difficult to actually achieve a desired carbon content in a weld due to transfer losses between the welding electrode and the resulting weld.

Accordingly, there is a need for a technique by which carbon contents can be selectively increased and controllably achieved in a weld.

Submerged Arc Welding (SAW) involves formation of an arc between a continuously-fed bare wire electrode and the workpiece. The process uses a flux introduced separately from the electrode to generate protective gases and slag, and to add alloying elements to the weld pool. A shielding gas is not required. Prior to welding, a thin layer of flux powder is placed on the workpiece surface. The arc moves along the joint line and as it does so, excess flux is recycled via a hopper. Remaining fused slag layers can be easily removed after welding. As the arc is completely covered by the flux layer, heat loss is extremely low. This produces a thermal efficiency as high as 60% (compared with 25% for manual metal arc welding). There is no visible arc light, welding is spatter-free and there is no need for fume extraction.

Weldments formed from submerged arc welding are prone to the same problem of decreased strength after stress relief as weldments produced by other welding techniques. However, prior artisans have not developed increased carbon content welding consumables for submerged arc welding to the same extent as for other welding technologies. That is, although fluxes for submerged arc welding operations are known which contain carbon, the concentration of carbon is relatively low, and generally insufficient to produce a weld deposit having sufficient carbon to avoid reductions in hardness or tensile strength.

Accordingly, there is a need for a flux specifically adapted for use in submerged arc welding that enables the formation of a weld having a relatively high carbon content.

### THE INVENTION

In a first aspect, the present invention provides a free flowing flux adapted for use in submerged arc welding. The flux is an agglomerated flux and includes at least one of (i) carbon additives, (ii) carbon-bearing agents, and (iii) combinations thereof. The total carbon content in the flux ranges from about 0.01 to about 0.6 percent by weight.

In another aspect, the present invention provides a free flowing flux adapted for use in submerged arc welding. The flux is a fused flux and includes at least one of (i) carbon additives, (ii) carbon-bearing agents, and (iii) combinations thereof. The total carbon content in the flux ranges from about 0.01 to about 0.6 percent by weight.

In yet another aspect, the present invention provides a free flowing flux adapted for use in submerged arc welding. The flux is a sintered flux and includes at least one of (i) carbon additives, (ii) carbon-bearing agents, and (iii) combinations thereof. The total carbon content in the flux ranges from about 0.01 to about 0.6 percent by weight.

In yet another aspect, the present invention provides a free flowing flux adapted for use in submerged arc welding. The flux includes a coating composition. The coating composition includes at least one of (i) carbon additives, (ii) carbon-bearing agents, and (iii) combinations thereof. The total carbon content in the flux coating ranges from about 0.01 to about 0.6 percent by weight.

These and other objects and advantages will become apparent from the following description taken together with the accompanying drawings.

### PREFERRED EMBODIMENTS

The present invention provides various strategies for increasing carbon contents in welds. Preferably, the strategies enable selective carbon contents to be obtained in welds and in a controllable fashion. The strategies are particularly directed to submerged arc welding.

In accordance with the present invention, selectively controllable carbon contents in weld deposits can be achieved by incorporating (i) one or more carbon additives and/or (ii) one or more carbon-bearing agents in a flux. The flux can be in a variety of different forms such as a flux coating composition, an agglomerated flux, a fused flux, and/or a sintered flux. The flux can be utilized in a cored electrode or as a separate free flowing flux composition used in a submerged arc welding process. The present invention provides techniques for increasing carbon content in a weld by utilizing the fluxes described herein in an electrode or as a free flowing flux in a submerged arc welding process.

Non-limiting examples of carbon additives include graphite, carbon black, high carbon, vitreous carbon, pyrolytic graphite, hexagonal graphite, diamond, and combinations thereof. If carbon black or graphite is used, a wide variety of different types of commercially available carbon black or graphite can be used.

Examples of suitable commercially available carbon blacks and graphite include those available from Southwestern Graphite of Burnet, Tex.; KETJEN BLACK® from Armak Corp.; VULCAN® XC72, VULCAN® XC72, BLACK PEARLS 2000, and REGAL 250R available fro Cabot Corporation Special Blacks Division; THERMAL BLACK® from RT Van Derbilt, Inc.; Shawinigan Acetylene Blacks available from chevron chemical Company; furnace blacks; ENSACO® Carbon Blacks and THERMAX carbon Blacks available from R.T. Vanderbilt Company, Inc.; and GRAPHITE 56-55.

As noted, the preferred embodiment fluxes can contain one or more carbon-bearing agents. The term “carbon-bearing agent” as used herein refers to an agent that contains carbon, however in chemically bound form. Carbon-bearing agents release carbon upon decomposition of the agent when exposed to high temperatures of the welding environment. Preferably, all or a portion of the flux or flux agent includes, or is coated or otherwise associated with a carbon-bearing agent. Non-limiting examples of such carbon-bearing agents include polytetrafluoroethylene (PTFE) and its various grades. Additional examples of preferred carbon-bearing agents include, but are not limited to, polyethylene, bakelite, or other hydrocarbons. Polytetrafluoroethylene, typically referred to as Teflon™ is in small, particulate powder form, so it can be evenly distributed throughout the flux composition or coating. Teflon™ has a tendency to be consumed by a burning action during welding. The high temperatures cause the polytetrafluoroethylene to disassociate and produce elemental carbon at the weld site.

In a particularly preferred embodiment, from about 0.1 to about 10% (by weight of the flux composition), more preferably from about 0.5 to about 8%, and most preferably from about 1 to about 2% PTFE is added to a flux cored electrode or to a free flowing flux composition. Preferred PTFE carbon-bearing agents for incorporation in the welding consumables described herein include, but are not limited to, unfilled PTFE, carbon filled PTFE, graphite filled PTFE, and combinations thereof. It is also preferred to utilize PTFE in a flux coating composition.

The various fluxes described herein can utilize (i) carbon additives alone, (ii) carbon-bearing agents alone, (iii) a combination of carbon-bearing agents and carbon additives, and (iv) a combination of carbon-bearing agents, carbon additives, and other carbon sources. For compositions of types (iii) and (iv), the ratio of carbon additives to carbon-bearing agents can range from about 0.01:100 to about 100:0.01 parts by weight respectively, more preferably about 0.1:10 to about 10:0.1, and in certain applications about 1:5 to about 5:1.

The total carbon content of the preferred embodiment fluxes ranges from about 0.01 to about 0.6% by weight of the flux. The specific carbon content is generally dictated by the end use application and by estimating transfer losses. For example, if a weld metal carbon content of 0.25% is desired, and if transfer loss is estimated to be 50%, then the carbon content of the flux is 0.5%. Alternately, if a 30% transfer is estimated and a weld metal carbon content of 0.18% is desired, the flux carbon content is 0.6%. The foregoing is based upon a system in which the flux is the only source of carbon. In the event that carbon is present in other welding feed sources, the calculations are adjusted accordingly.

The carbon additives and/or carbon-bearing agents can be incorporated in an agglomerated flux in which flux particles are dispersed within a binder. Alternatively, the carbon additives and/or carbon-bearing agents can be incorporated in a fused flux. Generally, for fused fluxes, the carbon additives and/or carbon-bearing agent can be added after fusing. Moreover, the carbon additives and/or carbon-bearing agents can be incorporated in a sintered flux.

As noted, the preferred embodiment fluxes can be utilized in a welding electrode such as a cored electrode. And, the preferred embodiment fluxes can be utilized in a separate free flowing flux such as used in a submerged arc welding process.

The preferred embodiment flux cored electrode includes a filling composition that enhances the deposition of the metal onto a workpiece and facilitates in obtaining the desired deposited metal composition. The filling composition typically includes, by weight percent of the electrode, about 5-15 weight percent slag system and the balance alloying agents. In one specific embodiment, the filling composition constitutes about 20-50 weight percent by electrode and includes, by weight percent of the electrode, about 8-12 weight percent slag system and the balance alloying agents.

In yet another preferred embodiment, the present invention provides a technique for increasing carbon content in a weld by incorporating iron powder, reground slag, or both, which can contain relatively high amounts of carbon into a welding consumable, and specifically, into the flux portion thereof. In certain applications, the various preferred embodiment fluxes described herein can include iron powder, reground slag, or both.

The preferred embodiment flux composition is particularly adapted for use in submerged arc welding processes, where high strength properties are desired. Generally, in such an application, a bare wire or stick electrode is fed to a workpiece. A separate flux feed, as described herein, is provided at or ahead of the electrode to generate protective gases and slag, and to optionally add alloying elements to the weld pool. Shielding gas is generally not required.

The preferred embodiment fluxes for submerged arc welding can be in a variety of forms for example, the fluxes can be in a fused form, a sintered form, or an agglomerated form. In addition, these flux compositions, or conventional flux compositions can be coated with the fluxes described herein.

In forming a fused flux, the flux ingredients are mechanically mixed with each other and the mixture is placed in a graphite crucible and heated until it melts. After heating the molten mixture for about 20 more minutes to insure complete fusion, it is quenched to room temperature and then ground and crushed to the desired granular size.

In forming a sintered flux, the sintering technique comprises making a mechanical mixture of the flux ingredients and heating in an oven at about 1650° F. for about 1½ hours. The mixture is then cooled, crushed, screened to obtain the desired particle distribution and used in the same manner as the fused material.

In forming an agglomerated flux, the flux can be prepared by a bonding technique in which the flux agents are combined with a binder (such as for example sodium silicate solution) in a ratio of about one part of binder to forty parts of the flux mixture. The mass is then heated to about 900° F. for 3 hours or more, crushed and screened to obtain the desired granular size.

Alternately, a preferred embodiment agglomerated flux is made by dry blending powders. The powders which are dry blended are generally sufficiently fine so as to pass through a 149 micrometer screen. After being thoroughly dry blended, an aqueous binder such as containing alkali metal silicate and a carbohydrate (e.g. invert sugar) is added to the dry blended ingredients. The dry and wet ingredients are then thoroughly blended and baked in air at about 480° to 540° C. for about 1-3 hours. After baking, the flux is removed from the baking equipment and crushed to convenient size.

The various flux compositions described herein can be specifically tailored to be basic, acidic, and/or neutral. Of the constituents set forth in the base flux, magnesium oxide, aluminum oxide and calcium fluoride are the typical components. The other materials used in the preferred embodiment, include the carbon additives, carbon-bearing agents, and other components dictated by the specific, end use application. Various modifications of the primary constituents and the remaining constituents can be made.

The raw materials used to prepare the flux of the present invention are preferably of the usual commercial purity, however incidental impurities that do not affect the function of the welding flux appreciatively may be present. The raw materials are preferably of a particle size that will pass through a 400-mesh screen.

The preferred embodiment fluxes, if in an agglomerated, fused, or sintered form, are preferably in a particulate or granular form. Although any particle size or size range can be used, it is generally preferred that the flux particles are of a size such that they can pass through a 10 US mesh size screen, more preferably a 12 US mesh size screen, and most preferably a 20 US mesh size screen.

Additional details of arc welding materials and specifically, cored electrodes for welding are provided in U.S. Pat. Nos. 5,369,244; 5,365,036; 5,233,160; 5,225,661; 5,132,514; 5,120,931; 5,091,628; 5,055,655; 5,015,823; 5,003,155; 4,833,296; 4,723,061; 4,717,536; 4,551,610; and 4,186,293; all of which are hereby incorporated by reference. Additional details of submerged arc welding processes, materials, and flux compositions are provided in U.S. Pat. Nos. 5,300,754; 5,004,884; 4,764,224; 4,675,056; 4,561,914; 4,500,765; 4,436,562; 4,338,142; and 4,221,611.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

Having thus defined the invention, the following is claimed:

1. A free-flowing flux adapted for use in submerged arc welding, the flux being an agglomerated flux, the agglomerated flux including at least one of (i) carbon additives, (ii) carbon-bearing agents, and (iii) combinations thereof, the total carbon content in the flux ranging from about 0.01 to about 0.6% by weight.

2. The flux of claim 1 wherein the carbon additive is selected from the group consisting of graphite, carbon black, high carbon, vitreous carbon, pyrolytic carbon, hexagonal graphite, diamond, and combinations thereof.

3. The flux of claim 1 wherein the carbon-bearing agent is polytetrafluoroethylene (PTFE).

4. The flux of claim 3 wherein the flux includes from about 0.1 to about 10% PTFE by weight of the flux.

5. The flux of claim 4 wherein the flux includes from about 0.5 to about 8% PTFE by weight of the flux.

6. The flux of claim 5 wherein the flux includes from about 1 to about 2% PTFE by weight of the flux.

7. The flux of claim 3 wherein the PTFE is selected from the group consisting of unfilled PTFE, carbon filled PTFE, graphite filled PTFE, and combinations thereof.

8. The flux of claim 1 wherein the flux further includes (i) iron powder containing carbon, (ii) reground slag containing carbon, and (iii) combinations thereof.

9. The flux of claim 1 wherein the flux is in the form of particles having a size such that the particles pass through a 400-mesh screen.

10. A free-flowing flux adapted for use in submerged arc welding, the flux being fused flux, the fused flux including at least one of (i) carbon additives, (ii) carbon-bearing agents, and (iii) combinations thereof, the total carbon content in the flux ranging from about 0.01 to about 0.6% by weight.

11. The flux of claim 10 wherein the carbon additive is selected from the group consisting of graphite, carbon black, high carbon, vitreous carbon, pyrolytic carbon, hexagonal graphite, diamond, and combinations thereof.

12. The flux of claim 10 wherein the carbon-bearing agent is polytetrafluoroethylene (PTFE)

13. The flux of claim 12 wherein the flux includes from about 0.1 to about 10% PTFE by weight of the flux.

14. The flux of claim 13 wherein the flux includes from about 0.5 to about 8% PTFE by weight of the flux.

15. The flux of claim 14 wherein the flux includes from about 1 to about 2% PTFE by weight of the flux.

16. The flux of claim 12 wherein the PTFE is an agent selected from the group consisting of unfilled PTFE, carbon filled PTFE, graphite filled PTFE, and combinations thereof.

17. The flux of claim 10 wherein the flux further includes (i) iron powder containing carbon, (ii) reground slag containing carbon, and (iii) combinations thereof.

18. The flux of claim 10 wherein the flux is in the form of particles having a size such that the particles pass through a 400-mesh screen.

19. A free-flowing flux adapted for use in submerged arc welding, the flux being a sintered flux including at least one of (i) carbon additives, (ii) carbon-bearing agents, and (iii) combinations thereof, the total carbon content in the flux ranging from about 0.01 to about 0.6% by weight.

20. The flux of claim 19 wherein the carbon additive is selected from the group consisting of graphite, carbon black, high carbon, vitreous carbon, pyrolytic carbon, hexagonal graphite, diamond, and combinations thereof.

21. The flux of claim 19 wherein the carbon-bearing agent is polytetrafluoroethylene (PTFE)

22. The flux of claim 21 wherein the flux includes from about 0.1 to about 10% PTFE by weight of the flux.

23. The flux of claim 22 wherein the flux includes from about 0.5 to about 8% PTFE by weight of the flux.

24. The flux of claim 23 wherein the flux includes from about 1 to about 2% PTFE by weight of the flux composition.

25. The flux of claim 21 wherein the PTFE is an agent selected from the group consisting of unfilled PTFE, carbon filled PTFE, graphite filled PTFE, and combinations thereof.

26. The flux of claim 19 wherein the flux further includes (i) iron powder containing carbon, (ii) reground slag containing carbon, and (iii) combinations thereof.

27. The flux of claim 19 wherein the flux is in the form of particles having a size such that the particles pass through a 400-mesh screen.

28. A free-flowing flux adapted for use in submerged arc welding, the flux including a coating composition, wherein the coating composition includes at least one of (i) carbon additives, (ii) carbon-bearing agents, and (iii) combinations thereof, the total carbon content in the coating composition ranging from about 0.01 to about 0.6% by weight.

29. The flux of claim 28 wherein the carbon additive is selected from the group consisting of graphite, carbon black, high carbon, vitreous carbon, pyrolytic carbon, hexagonal graphite, diamond, and combinations thereof.

30. The flux of claim 28 wherein the carbon-bearing agent is polytetrafluoroethylene (PTFE)

31. The flux of claim 30 wherein the flux includes from about 0.1 to about 10% PTFE by weight of the flux.

32. The flux of claim 31 wherein the flux includes from about 0.5 to about 8% PTFE by weight of the flux.

33. The flux of claim 32 wherein the flux includes from about 1 to about 2% PTFE by weight of the flux.

34. The flux of claim 30 wherein the PTFE is an agent selected from the group consisting of unfilled PTFE, carbon filled PTFE, graphite filled PTFE, and combinations thereof.

35. The flux of claim 28 wherein the flux further includes (i) iron powder containing carbon, (ii) reground slag containing carbon, and (iii) combinations thereof.

36. The flux of claim 28 wherein the flux is in the form of particles having a size such that the particles pass through a 400-mesh screen.
